(19) United States
(12) Patent Application Publication
(10) Pub. No.: US 2021/0065205 A1
(43) Pub. Date: Mar. 4, 2021

(54) CERTIFICATE ISSUING APPARATUS, COMMODITY SALES DATA PROCESSING APPARATUS, AND NON-TRANSITORY COMPUTER READABLE MEDIUM

(71) Applicant: TOSHIBA TEC KABUSHIKI KAISHA, Tokyo (JP)

(72) Inventor: Shunji ITAKURA, Tagata Shizuoka (JP)

(21) Appl. No.: 16/912,303

(22) Filed: Jun. 25, 2020

(30) Foreign Application Priority Data
Aug. 26, 2019 (JP) 2019-153987

(51) Int. Cl. G06Q 30/00; G06Q 20/40; G06Q 20/20

(52) U.S. Cl. CPC G06Q 30/018; G06Q 20/209; G06Q 20/401; G06Q 30/012

(57) ABSTRACT

According to an embodiment, a certificate issuing apparatus includes a processor that is configured to acquire commodity data relating to a commodity being purchased and for which a certificate can be issued. A paper type or a printer is then selected to be used for issuing the certificate from a plurality of paper types or a plurality of printers. The processor then issues data for printing the certificate on the selected paper type or the printed based on the commodity data.

This application is based upon and claims the benefit of priority from Japanese Patent Application No. 2019-153987, filed on Aug. 26, 2019, the entire contents of which are incorporated herein by reference.

### FIELD

Embodiments described herein relate generally to a certificate issuing apparatus, a commodity sales data processing apparatus, and a non-transitory computer readable medium.

### BACKGROUND

Conventionally, there has been proposed a commodity sales data processing apparatus having a function of issuing a certificate, a warranty certificate, proof of purchase document, or the like (hereinafter referred to as a certificate) of a commodity registered for sales. In the commodity sales data processing apparatus of this type, certificate data corresponding to a commodity code can be issued as a certificate for the particular commodity specified by the commodity code.

There are customers who prefer issuance of a certificate with a good appearance. For example, among foreign travelers, there may be a person who particularly requests a certificate having a good appearance, for example using clean or high-quality paper stock or the like when an expensive commodity has been purchased.

However, with the present technology related to the issuance of the certificate, the certificate is typically issued using the same paper types regardless of the contents of the goods or the transaction, thus it is difficult to meet the above request.

### BRIEF DESCRIPTION OF THE DRAWINGS

FIG. 1 depicts a POS system according to an embodiment.

FIG. 2 depicts an example of a data structure of a commodity master according to an embodiment.

FIG. 3 depicts an example of a data structure of a sales data file according to an embodiment.

FIG. 4 depicts a hardware configuration of a POS terminal according to an embodiment.

FIG. 5 depicts an example of a data structure of a printer setting information according to an embodiment.

FIG. 6 depicts a functional configuration of a POS terminal according to an embodiment.

FIG. 7 depicts an example of a sales certificate issued by an issuing unit according to an embodiment.

FIG. 8 depicts an example of a sales certificate issued by an issuing unit according to an embodiment.

FIG. 9 depicts an example of a sales certificate issued by an issuing unit according to an embodiment.

FIG. 10 depicts an example of a sales certificate issued by an issuing unit according to an embodiment.

FIG. 11 is a flowchart of a certificate issuance process performed by a POS terminal according to an embodiment.

### DETAILED DESCRIPTION

At least one embodiment provides a certificate issuance apparatus and a program to perform the certificate issuance in a more flexible manner.

According to one or more embodiments, a certificate issuing apparatus comprises a processor that is configured to acquire commodity data relating to a commodity for which a certificate can be issued. The commodity data indicates whether a certificate relating to commodity can be issued. The processor selects a paper type or a printer to be used for issuing the certificate from a plurality of paper types or a plurality of printers based on the acquired commodity data and then issues data for printing the certificate on the selected paper type or the printer based on the acquired commodity data.

Hereinafter, embodiments of a certificate issuing apparatus, a commodity sales data processing apparatus, and a program and its non-transitory computer readable medium will be described with reference to the accompanying drawings. In the present embodiments, a case where the commodity sales data processing apparatus and the program are applied to a Point-Of-Sales (POS) system used in a retail store or a shop will be described.

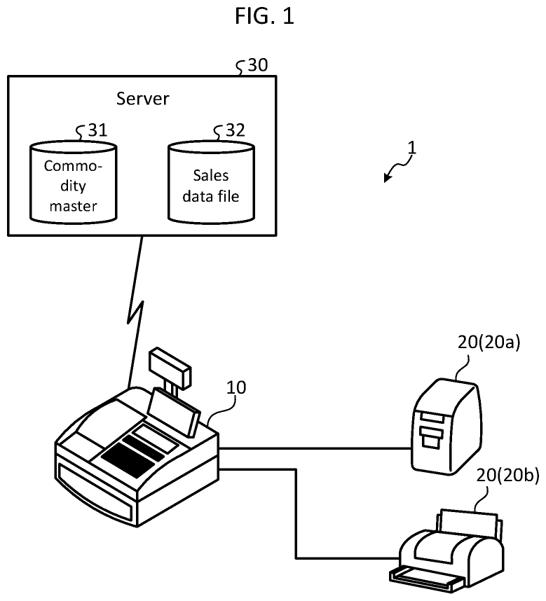

FIG. 1 is a diagram showing an example of the configuration of the POS system 1 according to one embodiment. As shown in FIG. 1, the POS system 1 comprises a POS terminal 10 which is an example of a certificate issuing apparatus, a printer 20 which is an example of a printing apparatus, and a server 30. Here, the POS terminal 10 and the printer 20 are connected to each other via a wired or wireless communication. The POS terminal 10 and the server 30 are connected to each other via a network such as a LAN (Local Area Network).

Although FIG. 1 shows an example in which one POS terminal 10 is connected to the server 30, the number of POS terminals 10 to be connected to the server 30 is not limited thereto. Although FIG. 1 shows an example in which two printers 20, that is a first printer 20a and a second printer 20b, are connected to a POS terminal 10, the number of printers 20 connected to the POS terminal 10 is not limited thereto. In the following description, when the first printer 20a and the second printer 20b are not distinguished from each other, they are simply referred to as the printer 20.

The server 30 is responsible for the data management of the entire POS system 1. The server 30 is an information processing apparatus. An information processing apparatus in this context may be a computer including a CPU (Central Processing Unit), a ROM (Read Only Memory), a RAM (Random Access Memory), and the like. The server 30 stores a program and a setting information related to the operation of the server, a commodity master 31 and a sales data file 32 in a storage device, such as a hard disk drive (HDD) or a solid state drive (SSD). The server 30 provides, in a referable manner, the commodity master 31 and the sales data file 32 to the POS terminal 10 connected to the server 30 via the network.

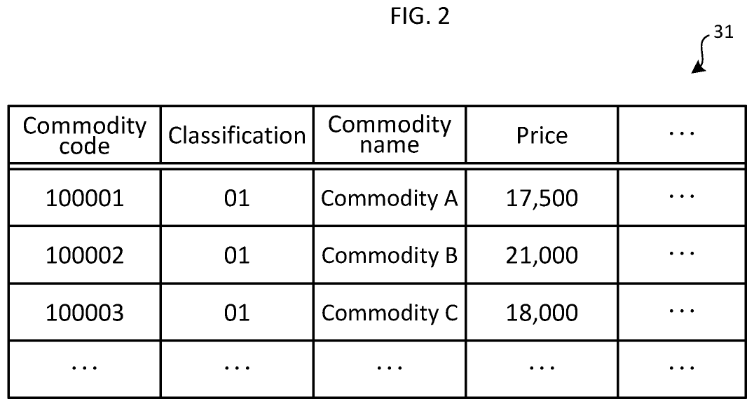

FIG. 2 is a diagram showing an example of the data structure of the commodity master 31. As shown in FIG. 2, the commodity master 31 stores commodity data such as “classification”, “commodity name” and “price” of the commodity in association with “commodity code” of each commodity. Here, the commodity code is identification information that is uniquely set for each commodity (hereinafter referred to as commodity identification information). The commodity identification information is used for identification of the commodity. For example, in a retail store, a label attached to the commodity is written with a code symbol such as a bar code. The classification is information indicating classification of a commodity classified based on a predetermined indexing or the like.

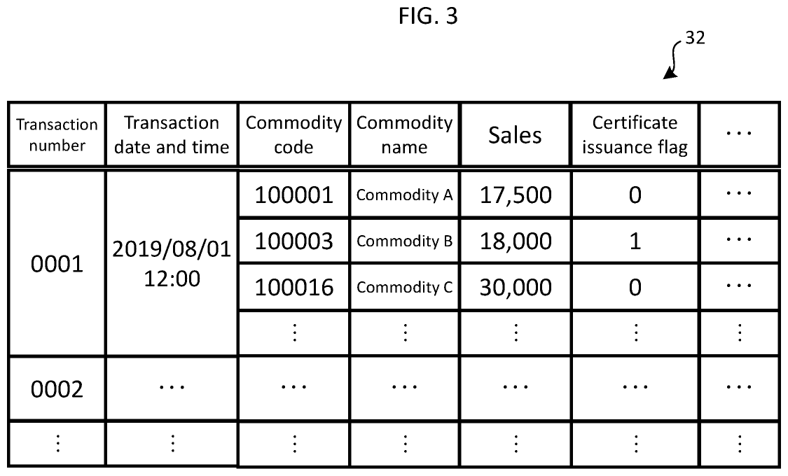

FIG. 3 is a diagram showing an example of the data structure of the sales data file 32. As shown in FIG. 3, the sales data file 32 stores sales data composed of items such as “transaction date and time”, “commodity code”, “commodity name”, “sales”, and the like in association with the “transaction number” of each transaction. The transaction code is identification information which is uniquely set for each transaction (hereinafter referred to as transaction identification information). The transaction identification information is used for identification of the transaction. The transaction date and time is date and time information indicating the date and time at which the transaction was performed. The commodity code, commodity name, and sales are commodity data provided for each commodity registered in the transaction (or otherwise associated with the same transaction code). The commodity data indicates a breakdown of the commodities purchased by a customer. Here, the “sales” value corresponds to a sales price for the commodity at the time when the commodity was sold.

The sales data is transmitted to the server 30 at the time of sales registration processing of the commodity from each of the POS terminal 10 provided in the retail store. The server 30 sequentially stores sales data transmitted from the POS terminal 10 in the sales data file 32.

The sales data file 32 stores a “certificate issuance flag” in association with each commodity code or commodity data included in the transaction data. The certificate issuance flag is flag information for identifying whether a sales certificate for certifying that the commodity has been sold (or purchased) has already been issued. The certificate issuance flag is represented by, for example, two values “0” or “1”. In this case, for example, the certificate issuance flag “0” means that the sales certificate has not been issued, and the certificate issuance flag “1” means that the sales certificate has been issued.

When the server 30 receives a notification for issuing the sales certificate including the transaction number and the commodity code (or the commodity data) from the POS terminal 10, the server 30 switches the certificate issuance flag corresponding to the transaction number and the commodity code (or commodity data) from “0” to “1”.

It should be noted that the data format of the certificate issuance flag is not limited to the example shown in FIG. 3. For example, one or more numerical values may be recorded so that the number of times the sales certificate is issued (or reissued) is recorded. In such a case, the server 30 adds one to the certificate issuance flag every time the issuance notification for the same transaction number and commodity code is issued from the POS terminal 10, thereby recording the number of times the sales certificate is issued to the server 30.

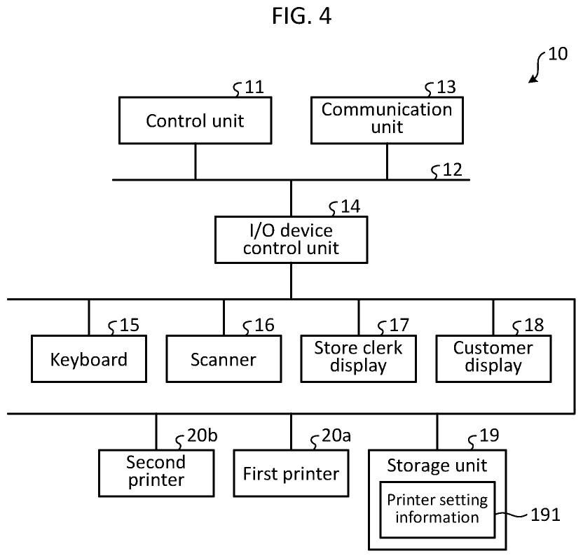

On the other hand, the POS terminal 10 is an example of the certificate issuing apparatus that issues a sales certificate. The POS terminal 10 is a terminal that is arranged at a checkout counter for performance of a sales process by a cashier or the like, and is configured as shown in FIG. 4.

FIG. 4 is a diagram showing an example of a hardware configuration of the POS terminal 10. As shown in FIG. 4, the POS terminal 10 includes a control unit 11 having a computer configuration including a CPU, a ROM, a RAM, and the like. The CPU is an example of a processor. The ROM stores various programs and various data to be executed by the CPU. The RAM temporarily stores data, programs or the like when the CPU executes various programs.

The control unit 11 is configured to execute online communication with the server 30 via the network by using the communication unit 13 connected via the bus 12.

A keyboard 15, a scanner 16, a store clerk display 17, a customer display 18, a storage unit 19, and the like are connected to the control unit 11 via the bus 12 and an I/O device control unit 14. Further, the first printer 20a and the second printer 20b are connected to the control unit 11 via the bus 12 and the I/O device control unit 14. The control unit 11 controls the overall operations of the respective units.

The keyboard 15 outputs information in response to the key operations (other user inputs) to the control unit 11. More specifically, dedicated operation keys for permitting input of various operations by an operator such as a store clerk are arranged on the keyboard 15. For example, the keyboard 15 can be provided with an index key for inputting a deposit amount or the like, a subtotal key for instructing the sum total for the commodities registered in a transaction, a certificate issue key for instructing the issuance of a sales certificate, and the like.

The scanner 16 reads information from code symbols such as a bar code or other two-dimensional code. For example, the scanner 16 reads the commodity code of the commodity from the code symbol attached to the commodity. The scanner 16 outputs the read information to the control unit 11.

The store clerk display 17 is a display device arranged for an operator who operates the POS terminal 10. The customer display 18 is a display device arranged for a customer who performs a transaction at the POS terminal 10. For example, a liquid crystal display or the like is used for the store clerk display 17 and the customer display 18, and a commodity name and a price of the commodity registered in the sales, and a total amount and a change amount, and the like of one transaction are displayed. The store clerk display 17 and the customer display 18 may be a touch panel display device.

The storage unit 19 is a storage device such as an HDD or an SSD. The storage unit 19 stores programs and setting information to be executed by the CPU. The storage unit 19 stores printer setting information 191 in which specifications and the like of the printer 20 are set.

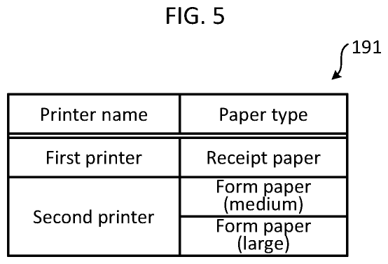

FIG. 5 is a diagram showing an example of a data structure of the printer setting information 191. As shown in FIG. 5, the printer setting information 191 stores “paper type” or the like in association with the “printer name” of each printer 20. Here, the printer name is identification information for identifying each of the printers 20. FIG. 5 shows an example in which “first printer” corresponding to the first printer 20a and “second printer” corresponding to the second printer 20b are set as the printer names.

The paper type is information indicating the type of paper which can be printed or issued by the printer 20. In FIG. 5, “receipt paper” is set as a paper type of the “first printer”, and two types of paper “form paper (medium)” and “form paper (large)” are set as paper types of the “second printer”. In this context, “form paper” can be a paper type including, for example, pre-printed information and/or images on each sheet. Such “form paper” may include blank lines and/or fields on or in which information (e.g., customer's name, today's date, sales totals, etc.) which might vary printing to printing can be printed. In some context, form paper may be referred to as ledger paper or the like. Such “form paper” may also be a specialized (e.g., watermarked) paper, decorative paper, and/or decorated paper with or without pre-printed information or images. In certain examples, “form paper” may be standard paper. That is, the first printer 20a in this example is a printer specialized for printing on a receipt paper, and the second printer 20b is a printer which can print two types of paper (e.g., form paper (medium) and form paper (large)) that are different in size from each other. The second printer 20b has, for example, a plurality of paper trays. Note that the different paper types are not limited to just differences in the paper size and different paper types may be based on paper quality, paper color, whether or not a decoration has been pre-applied to paper, or the like.

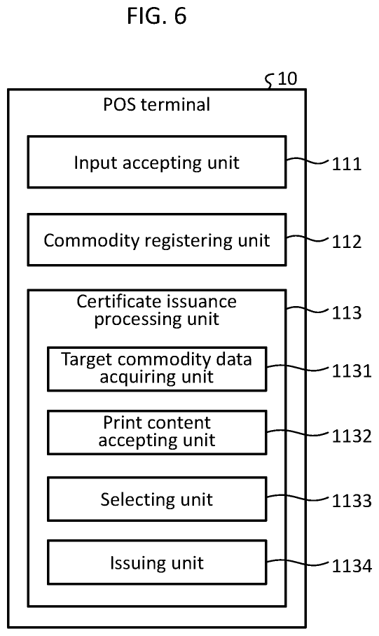

Next, the functional configuration of the POS terminal 10 will be described with reference to FIG. 6. FIG. 6 is a diagram conceptually depicting of a functional unit configuration of the POS terminal 10. As depicted in FIG. 6, the POS terminal 10 has an input accepting unit 111, a commodity registering unit 112, and a certificate issuance processing unit 113 as functional units. These functional units can be implemented by the CPU (processor) of the control unit 11 executing a program (instructions) stored in the ROM. Likewise, in some embodiments, some or all of these functional units, or more particularly the described functions thereof, may be realized by software executed by a processor (e.g., CPU) or otherwise as hardware configurations realized by dedicated circuits or various combinations of hardware and software.

The input accepting unit 111 receives information input via the keyboard 15, the scanner 16, and the like. For example, when the code symbol attached to the commodity is read by the scanner 16, the input accepting unit 111 accepts the input of the commodity code included in the code symbol. For example, when the transaction number of the transaction for which sales processing has been completed is input with the keyboard 15, the input accepting unit 111 accepts the input of the transaction number.

The commodity registering unit 112 performs processing associated with sales registration of the commodities based on information input with the keyboard 15 or the scanner 16. For example, when the input accepting unit 111 acquires a commodity code, the commodity registering unit 112 reads commodity data corresponding to the commodity code from the commodity master 31. When the subtotal key is pressed on the keyboard 15, the commodity registering unit 112 calculates the total amount for the transaction and calculates a change due amount in response to the input of a deposit amount. When the commodity registering unit 112 detects or is notified that the accounting (or settlement processing) for the commodities has been completed by the operation of the keyboard 15 or the like, it generates a list of commodity codes and commodity data input in the transaction, and also generates sales data which includes the transaction number for the completed transaction, the transaction date and time, the sales amount, the total amount, the deposit amount, the change amount and the like. The commodity registering unit 113 then transmits the generated sales data to the server 30. The sales data transmitted to the server 30 is registered in the sales data file 32. The commodity registering unit 112 controls the first printer 20a to issue a transaction receipt on receipt paper, on which the breakdown of the processing related to the sales registration (or sales processing), is printed. Note that the transaction number of the corresponding transaction can be printed in the form of a plain text, a code symbol, or the like on the receipt paper.

The certificate issuance processing unit 113 controls the issuance of the sales certificate. As shown in FIG. 6, the certificate issuance processing unit 113 includes a target commodity data acquiring unit 1131, a print content accepting unit 1132, a selecting unit 1133, and an issuing unit 1134.

The target commodity data acquiring unit 1131 acquires commodity data of the commodity for which sales certificate is to be issued. Specifically, when the issuance of the sales certificate is instructed by the operation of the certificate issue key or the like, the target commodity data acquiring unit 1131 acquires commodity data of the commodity, which is the issue target of the sales certificate, from the commodity master 31 or the sales data file 32 based on the information accepted by the input accepting unit 111.

For example, when the commodity code is input with the keyboard 15 and/or the scanner 16, the target commodity data acquiring unit 1131 reads out commodity data corresponding to the commodity code from the commodity master 31 and sets the commodity data as the target commodity data to be issued.

Further, for example, when the transaction number is input with the keyboard 15 and/or the scanner 16, the target commodity data acquiring unit 1131 reads the commodity data corresponding to the transaction number from the sales data file 32. The target commodity data acquiring unit 1131 displays a selection screen capable of selecting commodity data to be issued of a sales certificate among the read-out commodity data on the store clerk display 17 or the customer display 18. Then, the target commodity data acquiring unit 1131 sets the commodity data selected by the operator or the customer as the target commodity data to be issued.

It should be noted that one or more pieces of commodity data may be selected regardless of the number of selectable commodity data. For example, when a plurality of pieces of commodity data are selected, the issuing unit 1134 may issue a sales certificate for each piece of the selected commodity data or may issue one piece of sales certificate printed with information related to all pieces of commodity data.

The print content accepting unit 1132 accepts input of a character string or the like to be included on the sales certificate. Specifically, the print content accepting unit 1132 accepts a character string input by an operator via the keyboard 15 or the like as additional print content. Here, it can be possible to input character strings relating to various items regardless of the commodity data. For example, the print content to be received/accepted may be a name of a customer, a name and/or an address of a distributor or a store, or a name of an operator of the POS terminal 10.

When the character string to be input for various items is to be set in advance (e.g., store name/address may be set in advance), the print content accepting unit 1132 can provide the character string of each preset item as the print content.

The selecting unit 1133 selects a printer 20 from available printers to be used for issuing a sales certificate or selects a paper type from available paper types. Specifically, the selecting unit 1133 selects either, or both, the paper type and the printer 20 to be used to issue the sales certificate according to the information set in the printer setting information 191.

Here, various selection methods of the paper type or the printer 20 can be adopted. For example, the selecting unit 1133 may select the paper type or printer 20 to be used in accordance with the content of some predetermined element from among the elements included in the target commodity data. The possible elements in target commodity data are not particularly limited but may be the commodity price or sales value, commodity name, and the like.

As an example, the selecting unit 1133 selects the paper type or printer 20 in accordance with the price of the commodity included in the target commodity data. In this case, it may be preferable that the selecting unit 1133 selects a paper sheet having a larger paper size or the printer 20 capable of printing a paper sheet having a larger paper size as the price of the commodity becomes higher. Specifically, some threshold values can be provided in advance, and the selecting unit 1133 can be configured to select the paper type or printer 20 to be used to issue the sales certificate according to whether the price of the commodity exceeds one or more of the threshold values. For example, JPY1-JPY9,999 or less may be set as “receipt paper”, JPY10,000-JPY19,999 may be set as “form paper (medium)”, and JPY20,000 or more may be set as “form paper (large)”. Thus, the selecting unit 1133 can select the paper type or printer 20 according to the price of the commodity.

As another example, the selecting unit 1133 can be configured to select the paper type or printer 20 to be used for issuing the sales certificate in accordance with the commodity name or classification of the commodity. Specifically, the paper type or the printer 20 to be used to issue a sales certificate for each commodity name or classification can be set in advance. The selecting unit 1133 can be configured to select the printer 20 or a paper type corresponding to the commodity name or classification included in the target commodity data. Thus, the selecting unit 1133 can select the paper type or printer 20 as designated for the commodity name or the classification thereof.

Note that the selection method of the paper type or the printer 20 is not limited to the example described above. For example, the selecting unit 1133 may select the paper type or printer 20 that is specified by the operator (e.g., store clerk) with the keyboard 15 or the like. In this case, the selecting unit 1133 is configured to display the usable paper types or list of the printers 20 on the store clerk display 17 or the like based on the information set in the printer setting information 191. Then, the selecting unit 1133 selects the paper type or the printer 20 as specified with, e.g., the keyboard 15, for issuance of the sales certificate.

The issuing unit 1134 issues a sales certificate using the paper type or printer 20 selected by the selecting unit 1133. Specifically, the issuing unit 1134 refers to the printer setting information 191 and identifies a printer 20 that can handle the paper type selected by the selecting unit 1133 or otherwise the printer 20 selected by the selecting unit 1133. The issuing unit 1134 generates printing data to be shown in the sales certificate based on the target commodity data acquired by the target commodity data acquiring unit 1131 and the additional print content received and accepted by the print content accepting unit 1132. Then, the issuing unit 1134 controls the specified printer 20 to print the printing data on a paper sheet of the paper type selected by the selecting section unit 1133 or otherwise a paper sheet which can be printed by the printer 20 that was selected by the selecting unit 1133.

When the printer 20 selected by the selecting unit 1133 includes a plurality of paper types, the issuing unit 1134 may perform printing using a predetermined type of paper or determine a paper type to be used based on the remaining amount of paper or the like of each paper type.

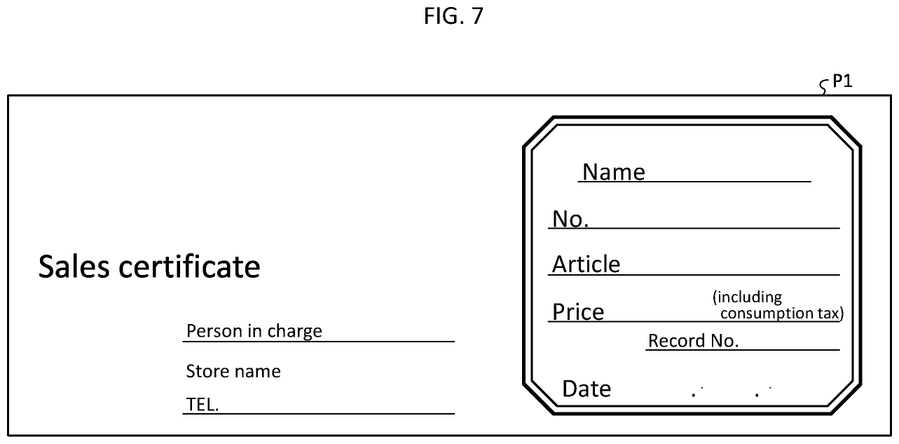

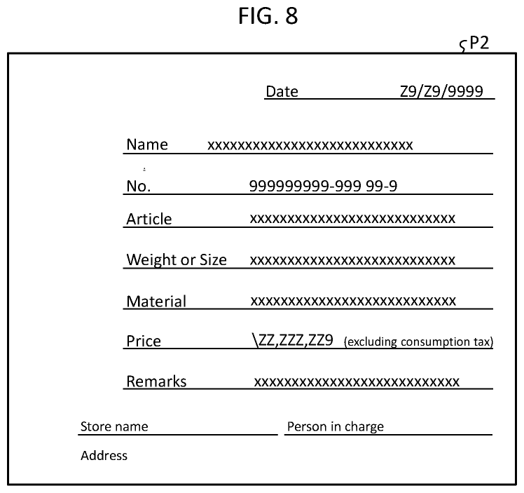

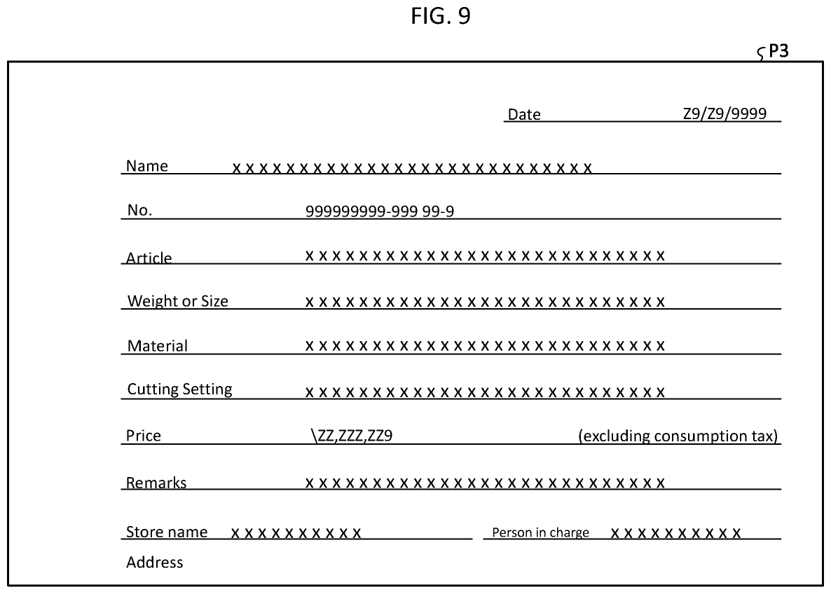

FIGS. 7 to 9 are diagrams, each showing an example of a sales certificate issued by the issuing unit 1134. Here, the sales certificate P1 in FIG. 7 depicts an example of a sales certificate printed by using the receipt paper. The sales certificate P2 in FIG. 8 is a diagram showing an example of a sales certificate printed by using a sheet of form paper (medium). The sales certificate P3 shown in FIG. 9 depicts an example of a sales certificate printed by using a sheet of form paper (large).

In each type of sales certificates P1 to P3, the contents to be printed are similar to each other. For example, contents based on target commodity data such as a commodity code or a commodity number, a commodity name, a price or a sales price and the like are printed on the sales certificate. In the sales certificate, a transaction date and time or a purchase date, a customer name, a distributor name or a store name, an address, a name of the person in charge or a name of the operator, and the like are printed. Here, for example, the customer name, the store name, the address, and the name of the person in charge are the print contents accepted by the print contents accepting unit 1132.

At the time of the issuance of the sales certificate, if the certificate issuance flag of the target commodity data stored in the sales data file 32 has “1” set thereto, which indicates that the issuance has already been done, the issuing unit 1134 issues a sales certificate with the information indicating reissuance.

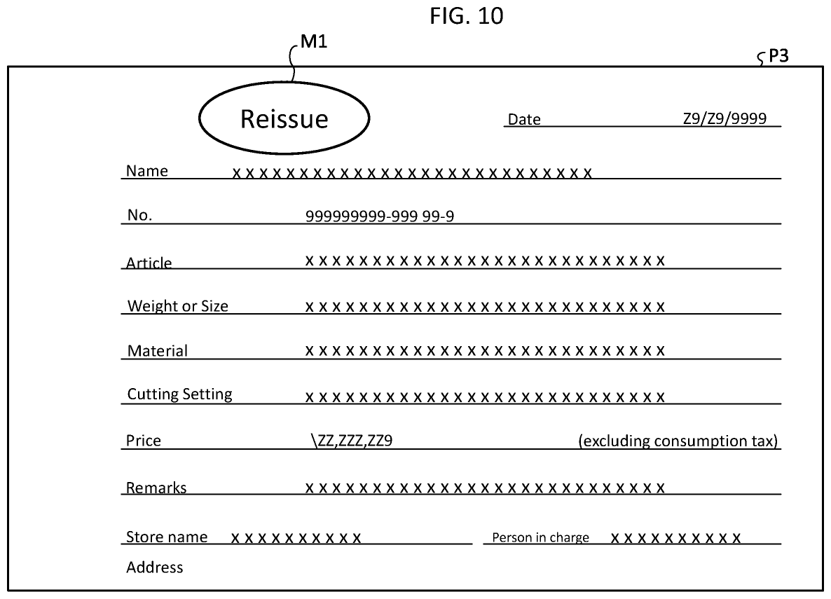

FIG. 10 is a diagram showing an example of a sales certificate issued by the issuing unit 1134 and shows a reissued sales certificate. In FIG. 10, the sales certificate P3 shown in FIG. 9 is explained as an example, but the other paper types may be reissued in a similar state.

As shown in FIG. 10, when “1” is set as the certificate issuance flag of the target commodity data, the issuing unit 1134 adds the reissue mark M1 indicating a reissuance has been performed. Thus, the customer or other user who has the sales certificate P3 can easily recognize that the sales certificate P3 has been reissued.

Further, when the certificate issuance flag is “0” is set as the certificate issuance flag, the issuing unit 1134 transmits an issuance notification including the transaction number and the commodity code (or commodity data) of the target commodity data to the store server 30. Thus, the store server 30 changes the certificate issuance flag that corresponds to the transaction number and commodity code (or commodity data) from “0” to “1” based on the issuance notification; therefore, if the sales certificate is ever issued again, the reissue mark M1 will be printed on the sales certificate.

When an issuance number (that is, a cumulative number of certificates issued for the commodity code) is recorded as the certificate issuance flag value, the issuing unit 1134 may issue the sales certificate with the information indicating the number of times a certificate has been issued (e.g., the third reissue) added thereto. Also, the issuing unit 1134 may be configured to determine whether to issue the sales certificate based on the cumulative number of times of certificate issuance recorded as the certificate issuance flag. In this case, for example, a threshold value indicating that the maximum number of (re)issuances can be possible is set in advance (for example, “2”); when the cumulative number of times of issuance as set in the certificate issuance flag is equal to or less than the threshold value, the issuing unit 1134 permits the issuance, but when the cumulative number exceeds the threshold value, the issuing unit 1134 will not permit another issuance.

When the target commodity data is acquired from the commodity master 31, the issuing unit 1134 may be configured to make the issuance of the sales certificate conditional on the completion of the registration process and/or the sales process of the target commodity data. In this case, when the commodity registering unit 112 transmits the sales data to the server 30, the issuing unit 1134 transmits an issue notification including the commodity code of the target commodity data to the server 30.

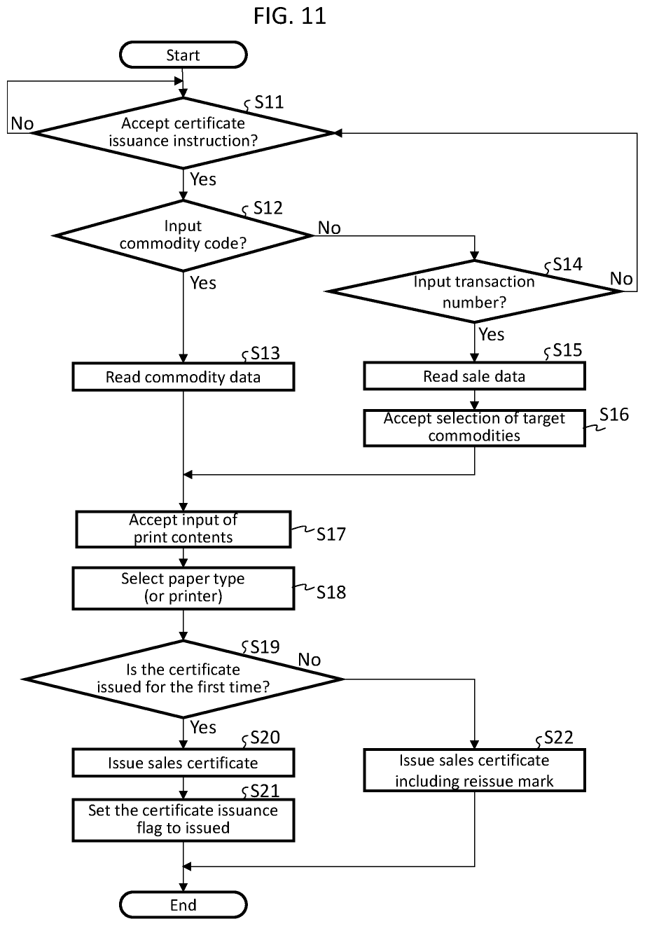

Next, an example of a certificate issuance process executed by the POS terminal 10 will be described with reference to FIG. 11. FIG. 11 is a flowchart showing the example of the certificate issuance process executed by the POS terminal 10.

First, the certificate issuance processing unit 113 waits until the issuance of the sales certificate is instructed by the operation of the certificate issuance key or the like (step S11; No). When the issuance of the sales certificate has been instructed, the target commodity data acquiring unit 1131 cooperates with the input accepting unit 111 to wait until the commodity code or the transaction number is input (step S12; No→step S14; No).

When the input of the commodity code is received (step S12; Yes), the target commodity data acquiring unit 1131 reads out the commodity data corresponding to the commodity code from the commodity master 31 (step S13). Then, the target commodity data acquiring unit 1131 sets the read-out commodity data that has been read out as the target commodity data and proceeds to step S17.

When receiving the input of the transaction number (step S14; Yes), the target commodity data acquiring unit 1131 reads the commodity data corresponding to the transaction number from the sales data file 32 (step S15). Then, when the target commodity data acquiring unit 1131 accepts the selection of the commodity data for which the sales certificate is to be issued from among the read-out commodity data (step S16), the target commodity data acquiring unit 1131 sets the selected commodity data as the target commodity data and moves to step S17.

Subsequently, the print content accepting unit 1132 accepts input of additional print content received via the keyboard 15 or the like (step S17).

Subsequently, the selecting unit 1133 selects the paper type or the printer 20 to be used for issuing the sales certificate (step S18). Specifically, in this example, the selecting unit 1133 selects the paper type or printer 20 to be used for issuing the sales certificate in accordance with the content of a predetermined element included in the target commodity data and the operation by the operator.

Subsequently, the issuing unit 1134 determines whether the issuance of the sales certificate is the first time based on the certificate issuance flag associated with the target commodity data (step S19). Here, if the certificate issuance flag is “0” indicating the first time, the issuing unit 1134 determines that it is the first time (step S19; Yes) and then proceeds to step S20.

In step S20, the issuing unit 1134 issues the sales certificate based on the target commodity data acquired by the target commodity data acquiring unit 1131 and the additional print content received by the print content accepting unit 1132, by using the paper type or printer selected by the selecting unit 1133 (step S20). Then, the certificate issuance processing unit 113 transmits the issuance notification (including the transaction number and the target commodity data or the commodity code of the target commodity data) to the server 30, sets the certificate issuance flag to indicate the certificate has been issued (step S21) and ends the process.

When the certificate issuance flag does not yet exist (e.g., the relevant sales transaction has not yet been completed) in step S19, the issuing unit 1134 determines that the issuance of the sales certificate is the first time (step S19; Yes). Then, the issuing unit 1134 may issue the sales certificate on the condition that the sales processing of the target commodity is ultimately completed in the background or otherwise of the processing in step S20. When the sales data including the target commodity is transmitted to the server 30, the issuing unit 1134 sets the certificate issuance flag of the target commodity to have been issued (step S21) and ends the process.

On the other hand, when the certificate issuance flag is “1” in step S19, the issuing unit 1134 determines that it is not the first time (step S19; No) and then proceeds to step S22. Then, the issuing unit 1134 issues the sales certificate including the reissue mark by using the paper type or the printer selected by the selecting unit 1133 (step S22) and ends the processing.

In this manner, according to the POS terminal 10 of the present embodiment, commodity data of the commodity to which a sales certificate is to be issued is acquired, and one paper type or printer 20 to be used for issuing the sales certificate is selected from a plurality of paper types or printers. Then, based on the acquired commodity data, the POS terminal 10 issues a sales certificate by using a paper of the selected paper type or the selected printer.

Thus, the POS terminal 10 can selectively use a plurality of paper types or printers for the issuance of the sales certificate, so that the sales certificate can be issued by using the paper type desired by a customer or the printer 20 capable of handling such a paper type. Therefore, the POS terminal 10 can flexibly issue the certificate on different papers or via different available printers.

The POS terminal 10 can be configured to select the paper type or printer 20 to be used for issuing the sales certificate based on a predetermined element included in the commodity data associated with the commodity for which the sales certificate is to be issued. Accordingly, the POS terminal 10 can selectively use the paper type and the printer 20 depending, for example, on the price or the commodity name included in the commodity data, so that the certificate can be issued flexibly.

Furthermore, the POS terminal 10 can be configured to record a certificate issuance flag indicating a certificate issuance in association with the commodity code or the commodity data of the commodity for which a sales certificate has already been issued and (re)issues the sales certificate with a mark indicating reissuance of the sales certificate. Thus, the POS terminal 10 can issue sales certificates for which it can be easily confirmed whether the sales certificate has been reissued, so that the convenience of the user can be improved.

When the commodity code of the commodity for which the certificate is to be issued is input, the POS terminal 10 acquires the commodity data corresponding to the commodity code from the commodity master 31. Thus, the POS terminal 10 can directly acquire the commodity data of the commodity of the issuance target from the commodity master 31. For example, the POS terminal 10 can issue a sales certificate from the commodity code read for sales registration in parallel with the sales processing of the commodity, so that the convenience of the issuance of the sales certificate can be improved.

When the transaction number for identifying the transaction is input, the POS terminal 10 acquires the commodity data of the commodity for which the sales certificate is issued from the commodity data (or sales data) corresponding to the transaction number stored in the sales data file 32. Thus, the POS terminal can acquire the commodity data of the commodity of the issuance target from the sales data in which sales registration has completed, so that the convenience for issuance of the sales certificate can be improved.

In the embodiment described above, the case of issuing a sales certificate is described as an example, but the certificate/document to be issued is not limited to this. For example, the present disclosure may be applied to a case in which a warranty certificate or the like providing for replacement or repair of the commodity such as is often available for a consumer electronic product.

Although a POS terminal 10 is described in the above embodiment, applicable devices or apparatuses are not limited to the POS terminal 10. For example, the present disclosure may be applied to an information processing apparatus such as a personal computer (PC) without the function of the commodity registering unit 112 which may be provided by the POS terminal 10. In this case, the information processing apparatus may issue a sales certificate only for a commodity for which other aspects of the sales processing has been done via a POS terminal 10 or the like.

The program to be executed in the POS terminal 10 of the example embodiment described above can be recorded on a non-transitory, computer-readable recording medium such as a CD-ROM, a flexible disk (FD), a CD-R, a DVD (Digital Versatile Disc), or the like, in an installable format or a file in an executable format.

Also, the program executed by the POS terminal 10 may be stored on a computer connected to a network such as the Internet and may be downloaded via a network. Further, the program executed by the POS terminal 10 may be provided or distributed via a network such as the Internet or the like.

Further, the program executed by the POS terminal 10 may be provided in advance in a ROM or the like.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A certificate issuing apparatus, comprising:
a processor configured to:
acquire commodity data for a commodity, the commodity data indicating whether a certificate relating to the commodity can be issued;
a select a paper type or a printer to be used for issuing the certificate from a plurality of paper types or a plurality of printers based on the acquired commodity data; and
issue data for printing the certificate on the selected the paper type or the printer based on the acquired commodity data.

2. The certificate issuing apparatus according to claim 1, wherein the processor is further configured to:
select the paper type or the printer to be used for issuing the certificate based on a predetermined element included in the commodity data.

3. The certificate issuing apparatus according to claim 1, wherein processor is further configured to:
record issuance information in association with the commodity data, the issuance information indicating whether the certificate has been previously issued; and
permit reissue of the certificate based on the recorded issuance information.

4. The certificate issuing apparatus according to claim 1, wherein the processor is further configured to:
accept input of commodity identification information.

5. The certificate issuing apparatus according to claim 4, wherein the commodity data is acquired from a commodity master file having the commodity identification information associated with the commodity data.

6. The certificate issuing apparatus according to claim 1, wherein the processor is further configured to:
accept input of transaction identification information.

7. The certificate issuing apparatus according to claim 6, wherein the commodity data is acquired based on the transaction identification information from a sales data file.

8. The certificate issuing apparatus according to claim 1, wherein the processor is further configured to:
accept input of additional content to be printed on the certificate.

9. A commodity sales data processing apparatus, comprising:
a point-of-sale (POS) terminal including a processor, the processor being configured to:
register commodities in a sales transaction and generate sales data corresponding to the sales transaction; identify a registered commodity in the sales transaction for which a certificate is to be issued according to acquired commodity data for the registered commodity;
a select a paper type to be used for issuing the certificate from a plurality of paper types based on the acquired commodity data of the registered commodity or the generated commodity sales data; and
issue data for printing the certificate on selected the paper type.

10. The commodity sales data processing apparatus according to claim 9, wherein the POS terminal further comprises a receipt printer configured to print receipts corresponding to the generated commodity sales data on receipt paper.

11. The commodity sales data processing apparatus according to claim 10, wherein the processor is configured to select receipt paper as the paper to be used for issuing the certificate when a sales total amount for the sales transaction is less than a predetermined threshold amount.

12. The commodity sales data processing apparatus according to claim 9, wherein the paper type is selected by issuing print data to a particular printer from among a plurality of printers.

13. The commodity sales data processing apparatus according to claim 9, further comprising:
a first printer connected to the POS terminal and configured to be loaded with a first paper type; and
a second printer connected to the POS terminal and configured to loaded with a second paper type and a third paper type at a same time.

14. The commodity sales data processing apparatus according to claim 9, wherein the processor is further configured to:
record certification issuance information in association with the commodity sales data, the certificate issuance information indicating whether the certificate has been previously printed; and
reissue the certificate if the recorded certificate issuance information associated with commodity sales data indicates the certificate has been previously printed less than a predetermined number of times.

15. A non-transitory computer readable medium storing a program therein, which when executed causes a computer to perform a process related to certificate issuance, the process comprising:
acquiring commodity data for a commodity, the commodity data indicating whether a certificate relating to the commodity can be issued;
a selecting a paper type or a printer to be used for issuing the certificate from a plurality of paper types or a plurality of printers based on the acquired commodity data; and
issuing data for printing the certificate on the selected the paper type or the printer based on the acquired commodity data.

16. The non-transitory computer readable medium according to claim 15, wherein selecting the paper type or the printer comprises selecting the paper type or the printer based on a predetermined element included in the commodity data.

17. The non-transitory computer readable medium according to claim 15, wherein the process further comprises:
recording issuance information in association with the commodity data, the issuance information indicating whether the certificate has been previously issued; and
permitting reissuance of the certificate based on the recorded issuance information.

18. The non-transitory computer readable medium according to claim 15, wherein the process further comprises:
accepting input of commodity identification information for registering commodities in a sales transaction, wherein
the acquiring of the commodity data comprises acquiring the commodity data corresponding to the commodity identification information from a commodity master file having the commodity identification information associated with commodity data.

19. The non-transitory computer readable medium according to claim 15, wherein the process further comprises:
accepting an input of transaction identification information for identifying a transaction, wherein
the acquiring the commodity data comprises acquiring the commodity data corresponding to the transaction identification information from a sales data file.

20. The non-transitory computer readable medium according to claim 15, wherein the process further comprises:
transmitting an issuance notification to a server after issuing data for printing the certificate on the selected paper type, the issuance notification including at least one of a transaction number, the commodity data, and a commodity code.
